(19) United States
(12) Patent Application Publication
(10) Pub. No.: US 2023/0167226 A1
(43) Pub. Date: Jun. 1, 2023

(54) SHAPE-MEMORY POLYMERS

(71) Applicant: UNIVERSITEIT GENT, Gent (BE)

(72) Inventors: Jasper DELAEY, Gent (BE); Jasper VAN HOORICK, Roosdaal (BE); Sandra VAN VLIERBERGHE, Sint-Niklaas (BE)

(21) Appl. No.: 17/922,168

(22) PCT Filed: May 6, 2021
(86) PCT No.: PCT/EP2021/062055

§ 371 Date: Oct. 28, 2022

(30) Foreign Application Priority Data
May 6, 2020 (EP) 20173167.6

(51) Int. Cl. C08G 18/42; C08G 18/32; C08G 18/22; C08G 18/67; C08G 18/75; C08G 63/08; C08G 63/85; C08G 63/91; C08J 3/24

(52) U.S. Cl. CPC C08G 18/428; C08G 18/4277; C08G 18/3206; C08G 18/227; C08G 18/672; C08G 18/755; C08G 63/08; C08G 63/85; C08G 63/912; C08J 3/24; C08G 2280/00; B33Y 10/00

(57) ABSTRACT

The present invention relates to shape-memory polymers, a method for providing said shape-memory polymers, uses and precursors thereof. More precisely, shape-memory polymers according to the present invention comprise end-capped urethane- and/or urea-based polymers having an amorphous backbone. Shape-memory polymers described herein provide for improved properties.

### FIELD OF THE INVENTION

The present invention relates to the field of shape-memory polymers and precursors thereof. More precisely, the present invention relates to shape-memory polymers which can more easily be processed, and precursors of said shape-memory polymers. Further, the present invention relates to methods of manufacture of said precursors and uses thereof.

### BACKGROUND TO THE INVENTION

Shape-memory polymers, also known as SMPs, is a class of polymers which are capable of changing their shape in a predefined way, in response to particular conditions e.g. heat, pressure, light, pH, solvent, . . . . More specifically, SMPs can “memorize” a macroscopic shape, be manipulated into a different temporary shape, and then under particular conditions return to said memorized shape. Among these, thermo-induced SMPs are the most studied. The range of applications of SMPs is largely determined by the tunability of their actuation temperature, degradation properties, mechanical properties, processability and/or solvent resistance. Shape-memory polymers can be used in several applications, whenever it is necessary to provide a material that is capable of “remembering” at least two different shapes in two different states e.g. thermal state, pressure state etc.

The several advantages of SMPs over other shape-memory materials, such as shape-memory alloys, is that SMPs are characterized by a high elastic deformation, low cost, low density, and potential biocompatibility and biodegradability. For these reasons, SMPs are for example suitable for biomedical applications.

For SMPs, the “memorized” macroscopic shape to which the polymer returns in response to a particular condition, is dictated during the cross-linking of the polymer chains of the SMP material itself. The cross-linking of said polymer can be categorized in mainly two types, physical cross-linking and chemical cross-linking. With respect to chemical cross-linking, covalent bonds are formed between different polymer chains, whereas in physical cross-linking, different polymer chains are associated by means of weaker interactions than the ones provided by covalent bonds.

SMPs which are physically cross-linked e.g. by crystallization, are usually less solvent- or temperature resistant, thereby limiting the spectrum of possible applications. On the other hand, SMPs which are chemically cross-linked are usually more solvent- and temperature resistant, but have limited processability. Usually, SMPs are cross-linked starting from a solution, this limits the different ways in which a permanent shape can be achieved. More specifically, conventional extrusion techniques or injection molding are usually not applied to chemically cross-linked SMPs due to the limited processability. The current generation of shape memory polymers often does not enable processing with additive manufacturing- or conventional melt-based processing techniques while ensuring solvent- and thermal resistance of the developed structures. More specifically, current SMPs have limited processability, for example, no lithographic techniques can be used with physically cross-linked SMPs, and no melt-based techniques can be used for SMPs which are chemically cross-linked.

Therefore, there is an industrial need for shape-memory polymers with improved properties, thereby overcoming the drawbacks in the prior art. The polymers disclosed in this application are capable of filling-in this need.

### SUMMARY OF THE INVENTION

In a first aspect, the present invention provides for a precursor comprising a polymer backbone connected to cross-linkable end-capping urethane- and/or urea units, wherein the polymer backbone has an amorphous backbone having a crystallinity of about 0%, wherein about means+/−5% or less, as measured by any of the following techniques: differential scanning calorimetry (DSC), dynamic mechanical thermal analysis (DMTA), and/or Wide-angle X-ray scattering (WAXS).

The precursor of the shape-memory polymer is per se a polymer that can be processed so to form a shape-memory polymer. In order to provide a shape memory polymer, the precursor of the shape-memory polymer has to be cross-linked, meaning that bonds between polymeric chains are formed. In the context of shape-memory polymers, the cross-linking provides a “permanent” shape to the material made out of said polymer. The precursors of shape-memory polymers described in the present invention have improved characteristics, that among others, provide for improved processability. It has been surprisingly found that an amorphous precursor provides for shape-memory characteristics to the cross-linked polymers described in accordance with the present invention, whilst retaining improved processability and tunability characteristics of the precursor of the memory-shape polymer.

Further, by means of the present invention, are hereby described precursors of shape-memory polymers which can be cross-linked by means of different cross-linking chemistries, due to the possibility of providing the urethane and/or urea-based polymers with a different end-capping that provides for cross-linking e.g. (meth)acrylates, thiol-ene chemistry (e.g. thiol-norbornene, thiol-vinyl ester, thiol-vinyl ether, . . . ) . . . .

Further, the present invention can provide for tailored shape-memory polymer precursors and shape-memory polymers for specific needs. For example, the end-cap and the polymer backbone can be selected to be compatible with applications which require high safety standards and controlling of the obtained precursors, such as biomedical applications, wherein, as a matter of example, the presence of free low-molar mass entities and leachables has to be avoided.

Further, the precursors in accordance with the present invention display shape-memory properties per-se after crosslinking, without the need for any reactive diluents.

Further, precursors in accordance with the present invention allow for the obtainment of shape-memory polymer precursors which can be provided homogeneous, and/or single component, without the need for further additives to be used to achieve shape-memory character in the cross-linked polymers, e.g. no need for amorphous forming reactive diluents to be used, or further co-polymerization steps to be accomplished.

In a preferred embodiment, the end-capped urethane- and/or urea-based polymer is of formula (I):

(Xₘ—Yₘ—Zₘ)ₙ—backbone (I)

wherein:
Xₘ represents a moiety comprising one or more cross-linkable functionalities;
Yₘ is selected from the list comprising: a direct bond or a spacer;
Zₘ represents a urethane- and/or urea-containing moiety;
backbone is an amorphous polymer, and wherein n is integer (e.g. 2, 3, 4, 5, . . . ) and defines the number of arm/branch connected to the backbone, wherein n≥2, and m is an enumerator (e.g. 1, 2, 3, 4, 5, . . . ) identifying each arm/branch.

In a further embodiment of the present invention, said backbone comprises amorphous polylactic acid (PLA), co-polymers and/or blends thereof. It has been found that polymer backbones comprising PLA provide for an optimal glass-transition temperature range and mechanical properties.

In accordance with an embodiment of the present invention, the polymer backbone has a glass transition temperature T_{g}≥−20° C., measured by means of differential scanning calorimetry (DSC), and/or dynamic mechanical thermal analysis (DMTA).

In accordance with an embodiment of the present invention, the precursor of the present invention consists of the polymer backbone connected to cross-linkable end-capping urethane- and/or urea units.

It is evident from formula (I) that the end-capped urethane- and/or urea-based polymers in accordance with the present invention can be provided in a variety of shapes. For example, in a particular embodiment, the precursor has a polymer shape selected from, but not limited to: star-shape, linear, hyperbranched, brush, comb, dumbbell, dendritic. In a specific embodiment, said star-shape is: 3-armed, 4-armed, 6-armed, preferably 6-armed shape.

In a further embodiment, the amorphous backbone has a molar mass Mn from about 500 to about 100000 g/mol, preferably 1000 to 50000 g/mol, more preferably 1500 to 20000 g/mol, as determined by means of 1H-NMR spectroscopy through end-group determination.

In a further embodiment, the end-capping content of the precursor according to the present invention is from about 0.2 to 300 mmol/g, preferably 0.3 to 250 mmol/g, more preferably 0.4 to 200 mmol/g.

In a further embodiment, the end-capping content (e.g. (meth)acrylic content) of the precursor according to the present invention is from about 0.2 to 300 mmol/g, preferably 0.3 to 250 mmol/g, more preferably 0.4 to 200 mmol/g.

In a further embodiment, the backbone of the precursor is selected from the list comprising: polylactic acid (PLA), polycaprolactone (PCL), polyglycolic acid (PGA), poly(ethylene terephthalate-ran-isophthalate) (PETI), polythioesters, acrylonitrile butadiene styrene (ABS), polycarbonate (PC), polyvinyl chloride (PVC), polysulfone (PSU), polystyrene (PS), polyalkyleneterephthalate (PAT), polyethyleneterephthalate glycol-modified (PETG), co-polymers and blends thereof.

In accordance with a further aspect, the present invention pertains to a precursor polymer solution, either solid or liquid, comprising a precursor according to any embodiment according to the present invention, and a diluent, either solid or liquid, chemically inert to the precursor.

Therefore, in accordance with the present embodiment, by means of the term precursor polymer solution, reference is made to either a liquid solution or a solid solution (e.g. a melt, or a precursor polymer mixture), depending on the physical state of the diluent used.

In another aspect, the present invention relates to the use of a precursor, or the polymer solution, as defined in any of the embodiments above. In a specific embodiment, the present invention relates to the use of said precursor in a method selected from the list comprising: multiphoton lithography, stereolithography (SLA printing), Digital light projection (DLP printing), electro-spinning, film casting, porogen leaching, extrusion based 3D-printing, inkjet 3D-printing, spray drying, cryogenic treatment, coatings, cross-linkable micelles, spin-coating, electro-spraying, melt-electro writing, doctor blading.

In another aspect, the present invention describes a method for providing a shape-memory polymer, comprising the steps of: (a) providing a precursor, or a precursor polymer solution of a shape-memory polymer according to any one of previous embodiments; (b) cross-linking the precursor, or the precursor polymer solution provided in step (a), thereby obtaining a cross-linked polymer having a first shape.

In a favorite embodiment in accordance with the present invention, at step (b) the precursor, or the precursor polymer solution, provided in step (a) is chemically cross-linked.

As already mentioned herein before, in the methods of obtaining a shape-memory polymer using the precursor or precursor solution according to the invention, no further cross-linking agents are required. In the methods according to the invention, the cross-linking can occur solely based on the introduced cross-linkable groups (i.e. acrylates, methacrylates) which are linked to the backbone via urea or urethane-groups either in the presence or absence of an additional spacer group in between the crosslinkable functionality and the urethane or urea groups.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings making apparent to those skilled in the art how the several forms of the invention may be embodied in practice.

FIG. 1, also abbreviated as FIG. 1, illustrates how the precursors of a shape-memory polymer according to the present invention can be programmed to have a shape-memory behavior, and how this behavior takes place.

FIG. 2A, 2B, 2C, also referred as FIG. 2A, 2B, 2C, show the synthesis of an example of precursors according to the present invention wherein said precursors are star shaped (3-4 arms) and linear precursors with a backbone of PDLLA-ran-PCL and an monoacrylate endcap with ethylene oxide spacer.

FIG. 3, also abbreviated as FIG. 3, illustrates a material made of a precursor of a shape-memory polymer being extruded by means of 3D printing.

FIG. 4A, also abbreviated as FIG. 4A, illustrates the final material obtained in FIG. 3, after it has been cross-linked by means of UV radiation, thereby creating a permanent shape, so to obtain a shape memory polymer as described in accordance with the present invention.

FIG. 4B, also abbreviated as FIG. 4B, illustrates the material made of the shape-memory polymer illustrated in FIG. 4A after it has been deformed.

FIG. 4C, also abbreviated as FIG. 4C, illustrates the material deformed in FIG. 4B after it has recovered its permanent shape.

FIG. 5, also referred to as FIG. 5, illustrates measurements of glass transition temperatures of potential backbones of the precursor as a function of the fraction of ε-caprolactone monomer in the PDLLA-ran-PCL copolymers.

FIG. 6, also referred to as FIG. 6, illustrates measurements of glass transition temperature of polymers according to the present invention.

FIG. 7, also referred as FIG. 7, shows a thermogravimetric analysis (TGA) thermogram of a precursor according to the present invention.

FIG. 8, also referred as FIG. 8, shows a differential scanning calorimetry (DSC) thermogram of a precursor according to the present invention.

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. When describing the compounds of the invention, the terms used are to be construed in accordance with the following definitions, unless a context dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

As used in the specification and the appended claims, the singular forms “a”, “an”, and “the” include plural referents unless the context clearly dictates otherwise. By way of example, “a polymer” means one polymer or more than one polymer.

The present invention provides for a precursor of a shape-memory polymer comprising an end-capped urethane- and/or urea-based polymer, wherein the end-capped urethane- and/or urea-based polymer has an amorphous backbone.

The shape-memory polymers that can be obtained from the precursors hereby described are characterized by tunable and improved mechanical and degradation properties. Further, said shape-memory polymers have superior characteristics, such as a superior temperature resistance in comparison to SMP's crosslinked based on physical interactions, that allow for a broader pallet of processing technologies to be used, including both processing methods where the polymer is processed from solution (lithographic techniques) as methods where the polymer is processed from a melt (extrusion based techniques, injection molding, . . . ). Moreover, the shape-memory polymers described herein possess a polymeric network that cannot be dissolved due to its chemical cross-links, making the shape memory polymers described in the present invention superior compared to the ones being provided with physical cross-links. In summary, the main benefit compared to physically crosslinked SMPs is the improved temperature resistance and chemical/solvent resistance. The main benefit compared to chemically crosslinked SMPs is a much wider pallet of processing options that is available.

In the context of the present invention, by means of the term “precursor of a shape-memory polymer”, as used herein, unless indicated otherwise, reference is made to a polymeric composition that is capable of obtaining shape-memory like properties upon cross-linking.

In the context of the present invention, by means of the term “shape-memory polymer”, as used herein, unless indicated otherwise, reference is made to a polymer capable of changing its conformation in a predefined way, in response to an external stimulus or command e.g. temperature, solvent . . . .

In the context of the present invention, the term “acrylate” is meant to be salts, esters and conjugate bases of acrylic acid and its derivatives. Acrylates contain vinyl groups, i.e. 2 carbon atoms double bonded to each other, directly attached to a carbonyl carbon. An acrylate moiety is typically represented as follows:

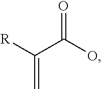

wherein R represents —H in the event of acrylates or an alkyl group such as for example a methyl (—CH₃) moiety, in the event of methacrylates. The (meth)acrylate groups according to the present invention are attached to the remainder of the polymer via the —O— linker, such that the double bonded carbon atom faces outwardly of the molecules.

In the context of the present invention, the term “acrylamide” is meant to be salts, amides and conjugate acids of acryl amide and its derivatives. Acrylamides contain vinyl groups, i.e. 2 carbon atoms double bonded to each other, directly attached to a carbonyl carbon. An acrylate moiety is typically represented as follows:

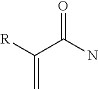

wherein R represents —H in the event of acrylates or an alkyl group such as for example a methyl (—CH₃) moiety, in the event of methacrylamides. The (meth)acrylate groups according to the present invention are attached to the remainder of the polymer via the —N— linker, such that the double bonded carbon atom faces outwardly of the molecules.

In another particular embodiment, the (meth)acrylate group is selected from the list including but not limited to ethoxylated and/or propoxylated pentaerythritol tri(meth)acrylate (EPPETA), pentaerythritol tri(meth)acrylate (PETA), dipentaerythritol penta(meth)acrylate (DPEPA), propoxylated glycerol di(meth)acrylate (PGDA), glyceroldiacrylate (GDA), oligo(ethylene oxide) (meth)acrylate (PEA), poly(ε-caprolactone) (meth)acrylate (PCLA) or the corresponding (meth)acrylamides and combinations thereof.

In a further embodiment, the end-capping content of the precursor according to the present invention is from about 0.2 to 300 mmol/g, preferably 0.3 to 250 mmol/g, more preferably 0.4 to 200 mmol/g. It has been found that the present end-capping content provides for the best mechanical properties of the obtainable SMPs therefrom.

In a further embodiment, the (meth)acrylic content of the precursor according to the present invention is from about 0.2 to 300 mmol/g, preferably 0.3 to 250 mmol/g, more preferably 0.4 to 200 mmol/g. It has been found that the present (meth)acrylic content provides for the best mechanical properties of the obtainable SMPs therefrom.

In the context of the present invention, by means of the term “end-capping content”, as used herein, unless indicated otherwise, reference is made to the content of the end-cap group e.g. (meth)acrylic moieties, norbornene moieties measured as end-cap density, which was determined by quantitative NMR.

In the context of the present invention, by means of the term “(meth)acrylic content”, as used herein, unless indicated otherwise, reference is made to the content of (meth)acrylic moieties measured as (meth)acrylate density, which was determined by quantitative NMR. For example, to determine the acrylate content in the presence of dimethyl terephthalate (DMT) as an internal standard, the formula here below has been used.

$$M ( acrylate ) = \frac{{I}_{6.4 ppm} + {I}_{6.12 ppm} + {I}_{5.83 ppm}}{{I}_{8 ppm}} * \frac{{N}_{8 ppm}}{{N}_{Acrylate}} * \frac{{M}_{DMT}}{M {W}_{DMT}} * \frac{1}{{M}_{Polymer}}$$

Where Iₓ indicates the integration of the NMR peak at x ppm, which peaks correspond to the acrylate. N is the amount of hydrogens associated with the peak at the ppm value, W_{DMT} and W_{Polymer} are the masses of DMT and the precursor respectively as used for the NMR measurement and MW_{DMT} is the molar mass of DMT. The formula for the determination of the methacrylate can be obtained in a similar way, in accordance with known methodologies.

The term “alkyl” by itself or as part of another substituent refers to a fully saturated hydrocarbon of Formula CₓH₂ₓ₊₁ wherein x is a number greater than or equal to 1. Generally, alkyl groups of this invention comprise from 1 to 20 carbon atoms. Alkyl groups may be linear or branched and may be substituted as indicated herein. When a subscript is used herein following a carbon atom, the subscript refers to the number of carbon atoms that the named group may contain. Thus, for example, C₁₋₄alkyl means an alkyl of one to four carbon atoms. Examples of alkyl groups are methyl, ethyl, n-propyl, i-propyl, butyl, and its isomers (e.g. n-butyl, i-butyl and t-butyl); pentyl and its isomers, hexyl and its isomers, heptyl and its isomers, octyl and its isomers, nonyl and its isomers; decyl and its isomers. C₁-C₆ alkyl includes all linear, branched, or cyclic alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers, cyclopentyl, 2-, 3-, or 4-methylcyclopentyl, cyclopentylmethylene, and cyclohexyl.

The term “end-capped” as used herein means that the cross-linkable functionalities of the molecules of the invention are located at the outer parts of the polymer molecules, i.e. they face outwardly of the molecules.

In the context of the present invention, the term “urethane- and/or urea-based polymer” is meant to be a polymeric polymer containing one or more carbamate or urethane links and/or carbamide or urea links. A carbamate is an organic compound derived from carbamic acid (NH₂COOH), and as such a carbamate link may be generally represented as follows:

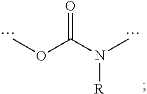

wherein each of said “ . . . ” represents an attachment point to the remainder of the polymer molecule. In the context of the present invention, the claimed polymers contain at least one carbamate linker, however, they may also contain several carbamate linkers such as 1, 2, 3, 4, or 5 carbamates. A carbamide is an organic compound derived from urea (NH₂CONH₂), and as such a carbamide link may be generally represented as follows:

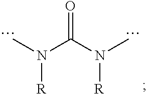

wherein each of said “ . . . ” represents an attachment point to the remainder of the polymer molecule. In the context of the present invention, the claimed polymers contain at least one carbamide linker, however, they may also contain several carbamide linkers such as 1, 2, 3, 4, or 5 carbamides.

In yet a further embodiment of the present invention, said urethane- and/or urea-containing moiety is a polyisocyanate moiety, such as selected from the list comprising diisocyanate moieties and trimers of polyisocyanates. More in particular said diisocyanate moiety is selected from the list comprising: cycloaliphatic diisocyanates, aliphatic diisocyanates and aromatic diisocyanates; preferably 5-isocyanato-1-isocyanatomethyl-1,3,3-trimethylcyclohexane (IPDI), 1,1′-methylene bis[4-isocyanatocyclohexane] (H12MDI), L-2,6-Diisocyanatohexanoic acid ethyl ester (LDI), 1,6-diisocyanatohexane (HDI), 1,6-diisocyanato-2,4,4-trimethylhexane (TMDI), 2,4-diisocyanatotoluene (TDI), 1,4-diisocyanatobenzene (BDI), 1,3-meta-tetramethylxylylene diisocyanate (TMXDI), and 1,1′-Methylenebis(4-isocyanatobenzene) (MDI); and derivatives thereof, such as 1,6-diisocyanatohexane biuret and isocyanurate. Alternatively said trimer of polyisocyanates is a trimer of 5-isocyanato-1-isocyanatomethyl-1,3,3-trinnethylcyclohexane (trimer of isophorone diisocyanate, IPDI).

In a preferred embodiment, the end-capped urethane- and/or urea-based polymer is of formula (I):

(Xₘ—Yₘ—Zₘ)ₙ—backbone (I)

wherein:
Xₘ represents a moiety comprising one or more cross-linkable functionalities;
Yₘ is selected from the list comprising: a direct bond or a spacer;
Zₘ represents a urethane- and/or urea-containing moiety;
backbone is an amorphous polymer, and wherein n is integer and defines the number of arm/branch connected to the backbone, wherein n≥2, and m is an enumerator for each arm/branch.

The present invention is in particular characterized in providing end-capped urethane- and/or urea-based polymer represented by formula (I). Herein Xₘ represents a moiety comprising one or more cross-linkable functionalities; Yₘ is selected from the list comprising: a direct bond or a spacer; Zₘ represents a urethane- and/or urea-containing moiety; and backbone is an amorphous polymer. Formula (I) is defined in that n is integer denoting the number of arms or branches connected to the backbone. In accordance with the present invention, n≥2 otherwise the backbone is not incorporated in between network-points, and m is a number denoting each portion of each arm or branch. For example, when n equals to 1, only one arm/branch is present attached to the backbone, when n equals to 4, 4 arms/branches are attached to the backbone and so on. Therefore, n can be selected from 2, 3, 4 . . . For example, m can also be selected from 1, 2, 3, 4 . . . , depending on the number of arms/branches present in the polymers according to the present invention. The various arms/branches can differ from one another, so that Xₘ, Yₘ and Zₘ can vary from end-capped urethane- and/or urea-based moiety to the other.

In a further embodiment, the present invention pertains to a precursor of a shape-memory polymer comprising an end-capped urethane- and/or urea-based polymer, wherein the end-capped urethane- and/or urea-based polymer has an amorphous backbone, and wherein the end-capped urethane- and/or urea-based polymer is of formula (I):

(Xₘ—Yₘ—Zₘ)ₙ—backbone (I)

wherein:
Xₘ represents a moiety comprising one or more cross-linkable functionalities;
Yₘ is selected from the list comprising: a direct bond or a spacer;
Zₘ represents a urethane- and/or urea-containing moiety; and

Wherein n is integer and defines the number of arm/branch connected to the backbone, wherein n≥2, and m is an enumerator for each arm/branch, and wherein said backbone comprises polylactic acid (PLA), for example PDLLA, co-polymers and/or blends thereof.

In the context of the present invention, the term “spacer” is meant to be a moiety intended to provide a (flexible) hinge between 2 other elements of the molecule in which it is included, thereby spatially separating said elements. In the context of the present invention, a spacer may be present between the X and Z components if desired. Said spacer may for example only be present at one side of the molecule, whereas it may be absent on the other side. In that respect Y₁ may for example be a spacer, whereas Y₂ may represent a direct bond and vice versa. In the context of the invention, any type of suitable moiety may be used as a spacer, however, it is preferably selected from the list comprising oligo-ethers, (such as ethylene oxide (EO) and propylene oxide (PO)), oligo-esters and combinations thereof. In accordance with the present embodiment, the spacers can comprise heteroatoms (atoms other than carbon atoms), such as 0, S or N, and have multiple carbon atoms. In an embodiment of the present invention, the spacers are saturated oligo-ethers or oligo-esters and combinations thereof.

The term “urethane- and/or urea-containing moiety” as used herein is meant to be a moiety composed of organic units joined by carbamate (urethane) links, i.e. —NH—(C═O)—O—; and/or urea links, i.e. —NH—(C═O)—NH—. Hence, this moiety may contain only urethane linkers. Alternatively, this moiety may contain only urea linkers. Moreover, this moiety may also contain a combination of urethane and urea linkers.

In an embodiment of the present invention, the precursor has a polymer shape selected from: star-shape, linear, hyperbranched, brush, comb, dumbbell, dendritic. In a specific embodiment, said star-shape is: 3-armed, 4-armed, 6-armed, preferably 6-armed shape. Generally, a higher branching will result in improved shape-memory properties. However, star shaped polymers with 3-6 arms and linear polymers have been found to be easier to achieve.

In a specific embodiment of the present invention, the backbone as suitable within the context of the invention may be selected from the list comprising: polyethers, polyamides, polysaccharides, polyoxazolines, polyvinyls and polyesters. The terms polyether, polyamide, polysaccharide, polyoxazoline and polyester are meant to represent polymer moieties containing multiple ether (R—O—R′), amide (R—C(═O)—NR′R″), saccharide (sugars, starch, cellulose, alginate, carrageenan, dextran), oxazoline (5-membered heterocyclic compound containing one 0 and one N atom) and ester (R—C(═O)—OR′) groups respectively.

More specifically, the backbone as suitable within the context of the present invention, may be selected from any of the following (and combinations, copolymers and blends thereof): polylactic acid (PLA); polycaprolactone (PCL); polyglycolic acid (PGA); poly(ethylene terephthalate-ran-isophthalate) (PETI); polythioesters; acrylonitrile butadiene styrene (ABS); polycarbonate (PC); polyvinyl chloride (PVC); polysulfone (PSU); polystyrene (PS); polyalkyleneterephthalate (PAT); polyethyleneterephthalate glycol-modified (PETG), polyethyleneterephthalate (PET), poly(D,L-lactic acid) (PDLLA), poly(D,L-lactic acid)-ran-polycaprolactone (PDLLA-ran-PCL).

In an embodiment according to the present invention, the backbone has a molar mass from about 500 to about 100000 g/mol, preferably 1000 to 50000 g/mol, more preferably 1500 to 20000 g/mol. It has been surprisingly found that molar mass ranges in accordance with the present invention provide for improved characteristics. Normally, it is expected that for molar masses that are too high the shape-memory properties will be non-existent or not practically usable. On the other hand, too low molar masses might result in a too brittle polymer with bad properties. The molar mass ranges hereby described could provide for neither of the abovementioned disadvantages. Molar masses of the backbone were measured before modification towards the precursor. For example, without being limiting, this can be done using either size exclusion chromatography (SEC) or NMR spectroscopy, matrix assisted laser desorption/ionisation time of flight mass spectroscopy (MALDI-TOF), viscosimetry, dynamic light scattering (DLS), when end group analysis is employed. In the latter, the integration of a proton associated with the end-groups is compared with the signal associated with the protons in the rest of the backbone, allowing for the calculation of the amount of repeating units in the backbone, which in turn allows for the determination of an average molar mass.

Therefore, the properties of the precursors of the SMPs according to the present invention can be tuned by modifying the parameters of the polymers itself. More specifically, the following variables can provide for different properties in the final SMP: (1) backbone molecular weight; (2) cross-link density; (3) architecture e.g. linear, star-shaped (3-armed, 4-armed, 6 armed etc), hyperbranched, multiacrylate; (4) backbone composition.

More specifically, a decreased molar mass/backbone length, an increased amount of arms on the architecture, multiacrylate presence, and increased cross-link density will all result in an improved shape-memory effect. Further, the backbone composition can be used to tune at which temperature the shape recovery is triggered, which is dependent on the glass transition temperature (T_{g}) of the backbone.

The compounds of the present invention can be prepared according to the reaction schemes provided in the examples hereinafter, but those skilled in the art will appreciate that these are only illustrative for the invention and that the compounds of this invention can be prepared by any of several standard synthetic processes commonly used by those skilled in the art of organic chemistry.

In the context of the present invention, by means of the term “amorphous”, as used herein, unless indicated otherwise, reference is made to a state characterized by a crystallinity lower than 10%, preferably about 0%. Crystallinity can be measured according to techniques in the state of the art, for example, it can be measured by means of Differential Scanning calorimetry (DSC) or Dynamic Mechanical Thermal Analysis (DMTA), wherein when the sample is analyzed with this technique, the absence of a crystallization peak indicates that the sample is amorphous or does not exhibit crystalline structures if analyzed using X-ray or electron scattering experiments. In the context of the present invention, only the precursor needs to be amorphous, something that can be possible when the unmodified backbone is crystalline. To ensure the obtainment of an amorphous precursor, it has been found best to use an amorphous backbone.

The precursors of shape-memory polymers obtainable in accordance with the present invention can be processed according to additive manufacturing techniques. More specifically, said precursors can be 3D printed using extrusion-based methods e.g. Fused Filament Fabrication (FDM), syringe printing, bioplotting, as well as be processed through other processing methods e.g. electro-spinning, Digital Light Processing (DLP), lithography methods . . . . A permanent shape of the shape-memory polymer can be applied after processing, by exploiting the solid-state cross-linkability of the polymers according to the present invention, upon electromagnetic irradiation e.g. UV-Vis, near IR, IR. The precursor of the shape-memory polymer can therefore be irradiated with electromagnetic irradiation so to provide the shape-memory polymer with its permanent shape.

In another aspect, the present invention relates to the use of a precursor as defined in anyone of the embodiments above. In a specific embodiment, the present invention relates to the use of said precursor in a method selected from the list comprising: multiphoton lithography, stereolithography (SLA printing), digital light processing (DLP), electro-spinning, film casting, porogen leaching, extrusion based 3D-printing, syringe printing, bioplotting, ink-jet printing, spray drying, cryogenic treatment, coatings, cross-linkable micelles, spin-coating, electro-spraying, melt-electro writing, doctor blading.

Multiphoton lithography is a method to generate 3D structures with sub-micrometer resolution upon simultaneous absorption of two or more photons by the photosensitive material. This is achieved by focusing ultra-short laser pulses into the photosensitive material, which initiates a chemical reaction limited to the focal region or volume pixel (voxel).

Stereolithography (SLA) and digital light projection (DLP) are additive manufacturing techniques that allow fabrication of structures using a computer-aided design (CAD) file. The fabrication of structures via SLA/DLP techniques is based on spatially controlled solidification of a liquid photosensitive resin using a computer-controlled laser beam or digital light projector. The surface (or bottom) of the resin is scanned by a laser to produce 2D patterns (laser-based systems) or the complete layer is cured at once by projecting a two-dimensional pixel-pattern (projection-based systems), where the fabrication platform moves in the Z-direction after curing of each layer to build up the 3D structure. After the process is completed, the non-cured resin is washed-off upon immersion into a suitable solvent.

Film casting is a method to create films by injecting a polymer melt or polymer solution between two glass plates separated with a spacer with certain thickness. The glass plates are subsequently irradiated with electromagnetic radiation e.g. UV radiation, to obtain cross-linked sheets.

Porogen leaching is a method to fabricate porous structures by mixing particles with the pre-polymer solution or melt, and selectively removing the particles from the cross-linked polymer using a suitable solvent.

Extrusion-based 3D printing, syringe printing and bioplotting are additive manufacturing techniques offering the design of either cell-free or cell-laden matrices via layer-by-layer deposition of the continuous strands. Two variations of this technique are available; printing from melt and printing from solution. The scaffolds can be irradiated with electromagnetic radiation during or after 3D printing in order to enable cross-linking.

Inkjet 3D printing is an additive manufacturing technique where liquid materials or solid suspensions are deposited by means of an ink-jet droplet controlled by microvalves. As a result, a liquid droplet is deposited in a certain pattern, followed by a curing step. Following a layer-by-layer deposition, 3D objects are formed with each layer adhering to the last, until the desired shape is achieved. Further, inkjet 3D printing can also be performed for fusing particles in a powder bed.

Cryogenic treatment is a method to create porous structures via a freeze-drying process. The polymer precursor is dissolved in water or another suitable solvent and the solution is then frozen to create ice crystals. The ice crystals are removed via freeze drying resulting in a porous polymer structure.

Coatings are top-layers formed on various substrates using pre-polymer solutions or melts. The pre-polymer layers can be applied on substrates using different techniques such as dip-coating, spin-coating, spray-coating, extrusion coating and subsequently cross-linked via electromagnetic irradiation.

Electro-spraying is a method to fabricate polymeric nano- or micro-particles by applying a high voltage electric field to the pre-polymer solution. The pre-polymer solution flowing out of a capillary nozzle is subjected to a high voltage electric field and forms a jet. The charged jet destabilizes due to the low concentration of the polymer solution and breaks down to fine particles being deposited on the collector. The fine particles formed due to the high voltage electric field are cross-linked using electromagnetic irradiation. The size of the droplets can be adjusted by varying the parameters such as solution concentration, flow rate and applied voltage, . . . .

In some of the above techniques, a photo initiator is used as detailed above. In a specific embodiment, said photo initiator is selected from the non-limiting list of 2-hydroxy-2-propyl 4-(hydroxyethoxy)phenyl ketone (Irgacure 2959), 1-hydroxycyclohexyl phenyl ketone (Additol CPK, available from Allnex), 1,4-bis(4-(N,N-bis(6-(N,N,N-trimethyl ammonium)hexyl)amino)-styryl)-2,5-dimethoxybenzene tetra iodide) (WSPI), lithium salt of 2,4,6-trimethylbenzoyldiphenylphosphine oxide (TPO), tetrapotassium 4,4′-(1,2-ethenediyl)bis[2-(3-sulfo-phenyl)diazenesulfonate] (DAS). Sodium 3,39-((((1E,19E)-(2-oxocyclopentane-1,3-diylidene) bis (methanylylidene))bis(4,1-phenylene))bis(methylazanediyl)) dipropanoate (P2CK), Sodium 2,29-((((1E,19E)-(5-methyl-2-oxocyclohexane-1,3-diyli-dene) bis (methanylylidene)) bis(4,1-phenylene))bis (methyla-zanediyl))diacetate (G2CK), Sodium 3,39-((((1E,19E)-(5-methyl-2-oxocyclohexane-1,3-diyli-dene)bis(methanylylidene))bis(4,1-phenylene))bis (methylaza-nediyl)) dipropanoate (E2CK), M2CMK, macromolecular photo initiators, or mixtures thereof. The selection of these photo initiators is of particular interest as they have been shown to display reduced cytotoxicity, see Li et al., 2013, and Tromayer et al., 2018. This is advantageous for biomedical applications.

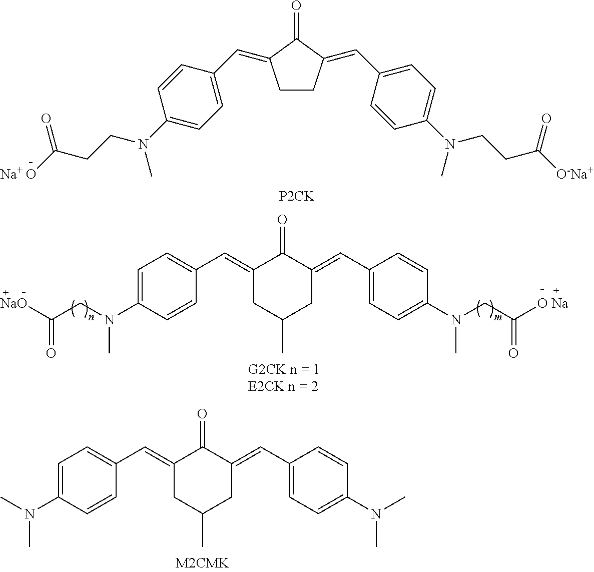

In another aspect, the present invention provides a shape-memory polymer, comprising the steps of: (a) providing a precursor of a shape-memory polymer, (b) cross-linking the precursor provided in step (a), thereby obtaining a cross-linked polymer having a first shape. In a preferred embodiment in accordance with the present invention, at step (b) the precursor provided in step (a) is chemically cross-linked.

The SMPs and precursors of SMPs described in accordance with the present invention can be of use, and not limited to, the medical industry, for example for the manufacturing of medical devices, implantable devices, injectable devices e.g. stents, and the non-medical industry, such as for the production of filaments for 3D printing, heat shrink tubes, heat-expandable foam for sealing of window frames, smart clothes that regulate heat and moisture, seatbelts.

In accordance with a further embodiment of the present invention, the polymer backbone has a glass transition temperature T_{g}≥−20° C., measured by means of differential scanning calorimetry (DSC) and/or dynamic mechanical thermal analysis (DMTA).

In another aspect, the present invention relates to a precursor polymer solution comprising the precursor according to any one of the embodiments of the present invention and as a diluent, either solid or liquid, a diluent chemically inert to the precursor. In accordance with the present aspect, a diluent chemically inert to the precursor is a diluent which is provided to not react chemically with the precursor, and is therefore a non-reactive diluent. By means of the term non-reactive diluent, reference is made to a liquid or solid not forming covalent bonds with the precursor. For example, the diluent can be a solvent, such as THF, which is capable of solubilizing, completely or partially, a precursor according to the present invention, without forming covalent bonds with one or more parts of the precursor, such as cross-linkable end-capping groups attached to the polymer backbone. Expressed differently, the precursors in accordance with the present invention display shape-memory properties per-se after crosslinking, without the need for any reactive diluents to be utilized.

Further, precursors in accordance with the present invention allow for obtaining cross-linked shape-memory polymers, using precursors according to the invention which can be provided homogeneous, and/or single component, without the need for further additives to be used to achieve shape-memory character in the cross-linked polymers, e.g. no need for reactive diluents to be used, or further co-polymerization steps to be accomplished.

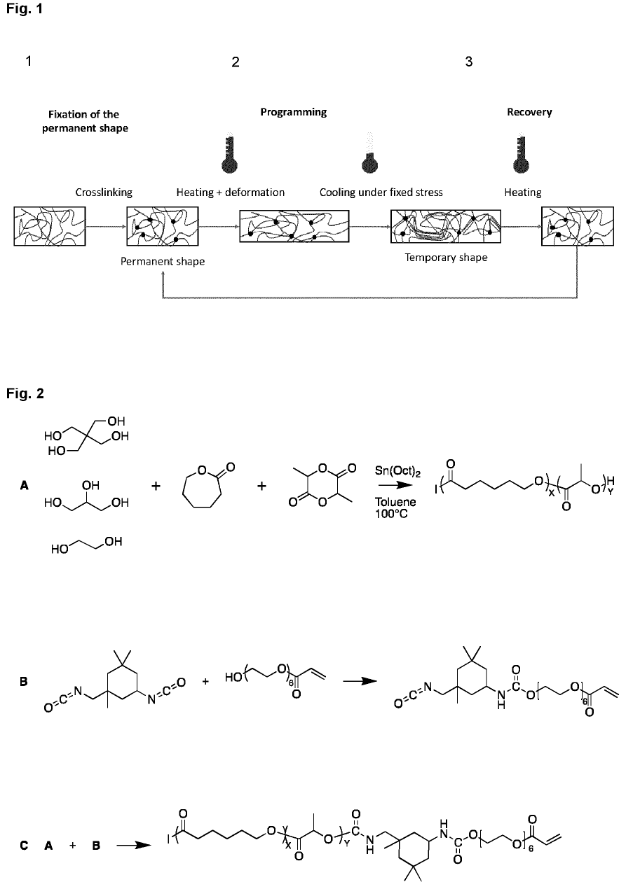

FIG. 1 shows a process allowing a material made of a precursor of a SMP to provide for shape-memory properties. From left to right, the figure illustrates: 1) fixation of the permanent shape of the material by cross-linking of the SMP precursor, thereby obtaining a SMP made material, 2) programming of the SMP material thereby allowing for a temporary shape, 3) providing the SMP material to recover its permanent shape. The permanent shape can be deformed by heating above the glass transition temperature and applying a mechanical stress. The stress is maintained during cooling, once the shape is cooled below the glass transition temperature, the shape will be maintained when the stress is removed. This shape is the temporary shape. When the temporary shape is heated above the glass transition temperature, the permanent shape will be recovered without the need for external manipulation.

### EXAMPLES

Materials and Methods

Materials

Ethyl acetate (Sigma-Aldrich) was dried by overnight stirring with MgSO₄ (Acros Organics), Toluene (Chem-Lab Analytical) and tetrahydrofuran (THF) (Chem-Lab Analytical) were refluxed with Sodium metal in the presence of benzophenone (Sigma-Aldrich) as an indicator before distillation, D,L-Lactide (Sigma-Aldrich) was purified by recrystallization in dry Ethyl acetate, ε-caprolactone (Sigma-Aldrich) was purified by vacuum distillation. Ethylene glycol and glycerol were dried by fractioned vacuum distillation, pentaerythritol (Acros Organics) was dried by azeotropic distillation in dry toluene. Sn(Oct)₂ (Sigma-Aldrich), Bismuth neodecanoate (Umicore Specialty Materials, Brugge), Methanol (Chem-Lab Analytical), Bisomer PEA6 (GEO specialty chemicals), Irgacure 2959 (Sigma-Aldrich), dimethyl therepthalate (DMT) (Sigma-Aldrich), butylated hydroxytoluene (BHT), Isophorone diisocyanate (IPDI) (Sigma-Aldrich), phenothiazine (PTz) and Triphenylphosphite (TPP) were used as received.

Methods

Synthesis

In accordance with the present invention, several different backbones can be used, such as polylactic acid (PLA), polycaprolactone (PCL), polyglycolic acid (PGA), poly(ethylene terephthalate-ran-isophthalate) (PETI) polythioesters, acrylonitrile butadiene styrene (ABS), polycarbonate (PC), polyvinyl chloride (PVC), polysulfone (PSU), polystyrene (PS), polyalkyleneterephthalate (PAT), polyethyleneterephthalate glycol-modified (PETG), polyethylene terephthalate (PET), poly(D,L-lactic acid) (PDLLA), poly(D,L-lactic acid)-ran-polycaprolactone (PDLLA-ran-PCL), co-polymers and blends thereof. To obtain backbones suitable to the present invention, different synthetic methodologies can be employed, part of the state of the art. The synthetic methodology employed here below, can be used to provide backbones and precursors of SMPs according to the present invention.

Synthesis of Multifunctional PLA/PCL Copolymers

FIG. 2A shows the synthesis route of linear, tri-, and four-armed PDLLA-PCL random block copolymers through ring-opening polymerization.

Ethylene glycol, glycerol and pentaerythritol were respectively used as initiators to obtain linear, tri-, and four-armed polymers. D,L-Lactide and ε-caprolactone were mixed with dry toluene. The mixture was subjected to three freeze-pump-thaw cycles to remove residual oxygen and put under Ar-atmosphere. The mixture was then heated to 100° C. Once complete dissolution of the monomers occurred, a mixture of the initiator and Sn(Oct)₂ as catalyst was injected in the monomer mixture to initiate the reaction. After 24 h of reaction, the polymer was precipitated in cold methanol. The purified polymers were dried in vacuo at 60° C. The copolymer composition was determined by monomer ratio.

Synthesis of the Endcap

FIG. 2B shows the synthesis of the end-capping reagent from the reaction of Bisomer PEA6 with IPDI.

IPDI was mixed with 500 ppm TPP and 500 ppm PTz to the final weight, put under Ar-atmosphere and heated to 70° C. 500 ppm of Bismuth neodecanoate was added. 1 equivalent of bisomer PEA6 was added dropwise to the mixture. The mixture was allowed to react for 2 h before increasing the temperature to 90° C. After another 1 h30 the final product was obtained and stored at 5° C. after cooling down.

Synthesis of the Precursor

FIG. 2C shows the synthesis of the final cross-linkable polymer obtained by reacting the end-capping reagent with the previously synthesized PDLLA/PCL copolymer.

Here, the copolymer was dissolved in THF (1:4 m/V) at 40° C. and put under inert atmosphere. After dissolution of the copolymer, the temperature was increased to obtain reflux conditions and 300 ppm of Bismuth neodecanoate was injected in the solution. 1 equivalent, relative to the hydroxyl functionalities of the endcap, was dissolved in THF (1:1 m/V) and slowly injected in the polymer solution. The reaction progress was monitored using FT-IR spectroscopy (2264 cm⁻¹). Once the isocyanate peak had disappeared the reaction was allowed to continue for 1 h and the resulting product was precipitated in liquid nitrogen-cooled hexane. The final product was dried in vacuo at 40° C.

Thermal Characterization

Thermogravimetric Analysis

Thermogravimetric analysis (TGA) was used to determine the degradation temperature of the synthesized polymers. At first the sample was equilibrated at a temperature of 45° C. Then a heating ramp of 10° C./min was used to reach a temperature of 600° C. Afterwards, the sample was equilibrated at 350° C. To do this, about 20 mg of sample was placed on a titanium pan to determine the mass during the measurement. The measurement was performed using a TA Instruments Q50 device. The results were analyzed using the Advantage/Universal Analysis (UA) software package.

Differential Scanning Calorimetry

Differential scanning calorimetry (DSC) was used to assess the crystallinity of the precursors and their backbones as well as to determine their glass transition temperatures.

Around 15 mg of sample was loaded in an aluminum Tzero pan and sealed with a perforated lid. An empty pan was used as reference. To start, the sample was equilibrated at a temperature of 45° C. The sample was then heated to 100° C. using a heating ramp of 10° C./min and kept at this temperature for 5 min. Consecutively, the sample was cooled to −50° C. with a ramp of 5° C./min and kept at this temperature for 5 min. The sample was then heated to 100° C. with a heating ramp of 10° C./min. The measurements were performed using a TA Instruments Q2000 device. The results were analyzed using the Advantage/Universal Analysis (UA) software package.

Chemical Characterization

NMR Spectroscopy

All ¹H-NMR spectra were recorded on a 400 MHz Bruker Avance II device.

Molar Mass

Molar masses were determined using end-group analysis of the synthesized backbone.

Acrylate Functionality

The acrylate density was determined by quantitative NMR spectroscopy in the presence of DMT.

$$M ( acrylate ) = \frac{{I}_{6.4 ppm} + {I}_{6.12 ppm} + {I}_{5.83 ppm}}{{I}_{8 ppm}} * \frac{{N}_{8 ppm}}{{N}_{Acrylate}} * \frac{{M}_{DMT}}{M {W}_{DMT}} * \frac{1}{{M}_{Polymer}}$$

Hydroxyl Functionality

The hydroxyl density of the backbone was determined via quantitative ¹H-NMR spectroscopy in the presence of DMT using the following formula:

$$M ( OH ) = \frac{{I}_{4.3 ppm}}{{I}_{8 ppm}} * \frac{{N}_{8 ppm}}{{N}_{4.3 ppm}} * \frac{{M}_{DMT}}{M {W}_{DMT}} * \frac{1}{{M}_{PLA}}$$

Where Iₓ indicates the integration of the NMR peak at x ppm, N is the amount of hydrogens associated with the peak at the ppm value, W_{DMT} and W_{PLA} are the masses of DMT and PLA respectively and MW_{DMT} is the molar mass of DMT.

Infrared Spectroscopy

Fourier transform Infrared Spectroscopy (FT-IR) analysis was performed using a Frontier FT-IR/FIR spectrometer.

Size Exclusion Chromatography

Size exclusion chromatography (SEC) was performed on the synthesized polyesters to determine their number average molar mass (Mn), weight average molar mass (Mw) and polydispersity index (PDI). The measurements were performed on a Waters corporation SEC device and detection occurred based on refractive index. Polystyrene standards (Mw from 2960 to 120000) were used to determine the molar mass. A PLGel Mixed-D LS polystyrene-divinylbenzene GPC column was used (300×7.5 mm×5 μm). A flow rate of 1 ml/min and a pressure of 26 bar were used.

Polymer Processing

Additive Manufacturing

Additive manufacturing was done using a SYS ENG Bioscaffolder Rapid Prototyping Instrument using an extrusion head.

Spin-Coating

Spin-coating was done using a spincoating, spin 150 table-top device.

### Example 1

Preparation of X1: 4-Armed Precursor with a Backbone of PDLLA with a MW of 11890 g/mol

Backbone reagents: 25 g D,L-lactide (173 mmol), 0.29 g pentaerythritol (2.17 mmol); 1.4 mL of Sn(Oct)₂ (4.34 mmol); 172 mL of dry toluene

Precursor synthesis: the backbone was reacted with 3.984 g of endcap in the presence of 0.007 g Bismuth neodecanoate (500 ppm) in dry THF. 1 mg of BHT (2700 ppm) was added to the initial mixture. The reaction was allowed to continue for 18 h, resulting in a brownish final product; 10 mg of PTz (500 ppm on total mass) and 10 mg of TPP (500 ppm on total mass) were added after completion of the reaction. No precipitation was performed after the synthesis of this material.

Additive Manufacturing of X1

X1 (as described in example 1) was 3D printed using the following parameters:

| Parameter | Value |
|---|---|
| Spindle speed | 80 rpm |
| Layer thickness | 0.2 cm |
| Needle number | 20 |
| Length | 9.5 cm |
| Needle diameter | 0.2 cm |
| Preflow | 0.2 |
| F_{xy} | 100 |
| Postflow | 0.2 |
| Cor delay | 0 |
| F_{z} | 0 |
| S | 80 |
| S_{pullback} | 100 |
| T_{pullback} | 0.8 |
| Pressure | 5 bar |
| Pattern | 90° |
| Strand distance | 2 mm |
| Temperature | 80° C. |

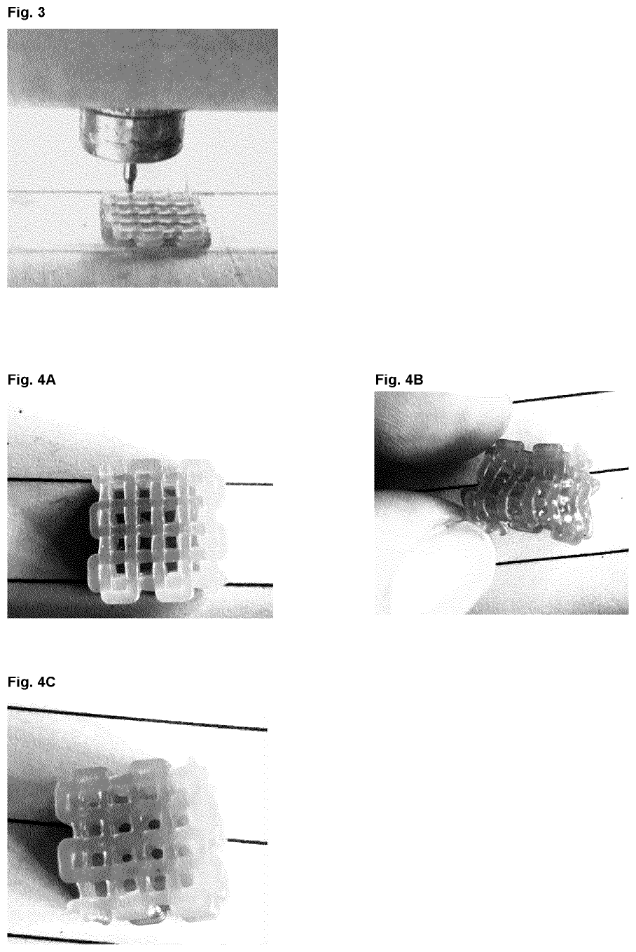

FIG. 3 shows a material made of a precursor of a SMP according to the present invention, precursor X1, being extruded by means of a 3D printing technique.

After the additive manufacturing, the print was irradiated using UV-A (7.6 mW/cm²) for 30 minutes to cross-link the polymer. The resulting print is shown in FIG. 4A.

FIG. 4A shows the shape of the material being 3D printed in FIG. 3, after it is cross-linked by means of UV-radiation, so to form a SMP material. The SMP material shown in FIG. 4A is in its permanent shape, which shape has been made permanent by cross-linking.

Solvent Casting of X1

X1 was dissolved in THF (10 wt %) and injected in between 2 glass plates separated by a spacer. The construct was then irradiated using UV-A (7.6 mW/cm²) for 30 minutes to cross-link the polymer. The glass plates were removed, and the resulting polymer film was dried at room temperature, resulting in a transparent, flexible, thin film of cross-linked X1.

Spin-Coating of X1

X1 was dissolved in THF (4 wt %) and spin-coated using the following parameters:

| Parameter | Value |
|---|---|
| Volume | 250 μL |
| Acceleration | 1000 RPM/s |
| Speed | 3000 RPM |
| Time | 60 s |

Shape-Memory of X1 3D-Prints

The shape-memory effect in the 3D prints was assessed by immersing the print in hot water (100° C.) and mechanically deforming it. The mechanical force was maintained until the print cooled down upon which point no force was necessary to maintain the deformation.

FIG. 4B shows the SMP material shown in FIG. 4A after it has been mechanically deformed. The polymer is now in its temporary shape.

The recovery of the temporary shape was triggered by immersing the deformed shape in hot water (100° C.).

FIG. 4C shows the SMP material shown in FIG. 4B after it has recovered its permanent shape. The recovery of the permanent shape has been achieved by exposing the deformed SMP material illustrated in FIG. 4B to a heat source, more specifically by plunging the material in hot water (100° C.), until the shape of the SMP material changes to the permanent shape, as in FIG. 4A.

Shape-Memory of X1 Casts

The shape-memory effect in the films was assessed by heating up the cross-linked film in an oven (100° C.), followed by twisting the film. The force on the twisted film was maintained until the film cooled down and no force was necessary to maintain the deformation. The recovery of the twisted shape was triggered by heating the shape in an oven (100° C.).

### Example 2

Preparation of X2: 2-Armed (Linear) Precursor with a Backbone of a PDLLA-PCL (6% PCL) Copolymer with a MW of 8260 g/mol

Backbone reagents: 18.8 g D,L-lactide (130 mmol); 1.17 mL ε-caprolactone (10.5 mmol); 141 μL Ethylene glycol (2.5 mmol); 1.02 g Sn(Oct)₂ (2.5 mmol); 127 mL Toluene Precursor synthesis: 10 g of the backbone was reacted with 1.47 g of the endcap in the presence of 0.3 mg BHT (2700 ppm) and 3.4 mg of Bismuth neodecanaoate (500 ppm). Post reaction 5.7 mg of PTz and TPP were added (500 ppm on total mass).

Results

Processability of the Precursor.

FIG. 3 demonstrates that the precursors can be processed using extrusion-based techniques such as extrusion-based 3D-printing. Further, the precursors can be obtained also by means of solvent casting, showing that processing methods for which the precursor needs to be dissolved are possible. Additionally, the precursor has also been successfully spin-coated. However, due to the nature of the precursor, more processing techniques than the ones currently tested should be feasible. All of these tests have been performed using precursor X1.

Tunability of the Glass Transition Temperature by Backbone Selection

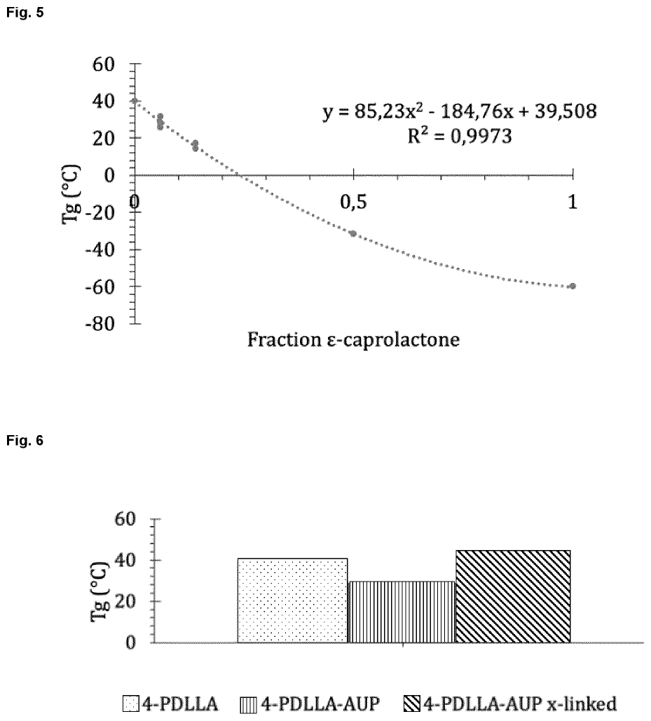

It Is clear that the backbone selection plays an important role on the temperature at which the shape-memory effect triggers. By selecting a correct backbone, the temperature at which the shape-memory effect is triggered can easily be manipulated. An example is the copolymerization of PDLLA and PCL where the ratio in-between the 2 monomers influences the glass-transition temperature as can be seen in FIG. 5.

FIG. 5 plots the glass transition temperature of potential backbones of the precursor as a function of the fraction of ε-caprolactone monomer in the PDLLA-ran-PCL copolymers. Glass transitions were determined using DSC.

Since the recovery of the permanent shape in the reported shape-memory polymers is triggered by heating the cross-linked precursor above their glass transition temperature, tuning the glass transition temperature of the backbone allows for a facile manipulation of the shape-memory polymer. It has been demonstrated using precursor X1 that after the modification of the backbone into the precursor, the glass transition temperature drops, most likely due to the plasticizing effect of the spacer units. However, upon cross-linking of the precursor, the T_{g} approaches the T_{g} of the backbone. This indicates that the glass transition temperature of the backbone gives a good prediction of the glass transition temperature of the cross-linked precursor, exhibiting shape-memory properties. Therefore, the glass transition temperature of the backbone can be used to predict at which temperature the cross-linked precursor will be triggered to recover its shape.

FIG. 6 illustrates measures of glass transition temperature for 4-PDLLA. PDLLA is the backbone of precursor X1, 4-PDLLA-AUP is precursor X1 and 4-PDLLA-AUP x-linked is the cross-linked precursor.

Feasibility of Different Backbones

Both the synthesis of Example 1 (X1) and Example 2 (X2) resulted in a successful modification of the backbone towards a precursor material. However, X1 has a PDLLA backbone while X2 has a random copolymeric backbone of PDLLA and PCL (PDLLA-ran-PCL) backbone containing 6 wt % of PCL. Despite the different backbone, modification of the polymers was successful. This indicates that a multitude of backbones can be used for the synthesis of the precursor. Additionally, the tables below show different precursors with backbones that differ both in architecture and molar mass.

| Material | Shape (# | PDLLA—PCL | Acrylate content | Backbone —OH |
|---|---|---|---|---|
| code | arms) | content (%) | (mol/g) | content (mol/g) |
| X1 | Star (4) | 100-0 | 3.30E−04 | 2.81E−04 |
| X2 | Linear (2) | 94-6 | 1.93E−04 | 2.63E−04 |
| X3 | Star (4) | 94-6 | ND | 3.10E−04 |
| X4 | Linear (2) | 94-6 | ND | 3.79E−03 |
| X5 | Linear (2) | 90-10 | ND | 1.36E−04 |
| X6 | Linear (2) | 94-6 | ND | 2.48E−04 |
| X7 | Star (3) | 100-0 | ND | 3.26E−04 |
| X8 | Star (4) | 100-0 | ND | 3.42E−4 |
| X9 | Linear (2) | 100-0 | ND | 9.73E−5 |
| X10 | Star (4) | 100-0 | ND | ND |
| X11 | Linear (2) | 100-0 | ND | ND |

Molar Masses of the Synthesized Precursors

| | Backbone | Backbone | Backbone | | |
|---|---|---|---|---|---|
| | mass as | mass (Mn) as | mass (Mw) as | | |
| | determined | determined | determined | Corrected | |
| Material | by NMR | by GPC | by GPC | Mn* | |
| code | (g/mol) | (g/mol) | (g/mol) | (g/mol) | Ð |
| X1 | 11,890 | 15344 | 12638 | 8900 | 1.21 |
| X2 | 8,260 | Not | Not | Not | ND |
| | | determined | determined | determined | |
| X3 | 2,420 | 4241 | 3979 | 2460 | 1.1 |
| X4 | 2,590 | ND | ND | ND | ND |
| X5 | 19,750 | ND | ND | ND | 1.01 |
| X6 | 7,340 | ND | ND | ND | ND |
| X7 | 9,339 | ND | ND | ND | ND |
| X8 | 11,886 | ND | ND | ND | ND |
| X9 | 21,128 | ND | ND | ND | ND |
| X10 | 12,143 | 7787 | 9502 | 4520 | 1.22 |
| X11 | 3,924 | 5479 | 7027 | 3180 | 1.28 |

The table above shows that the precursor can be synthesized using various molar masses as backbone. The correction factor used for the Mn is the correction factor for PLA as reported in literature (0.58) see Alba et al., 2015.

Thermal Stability and Glass Transition Temperatures of the Precursors

| Material | | |
|---|---|---|
| code | T_{g} (° C.) | T_{deg} onset (° C.) |
| X1 | 28.94 | 216.56 |
| X2 | 33.96 | 211.93 |
| X3 | 1.51 | 235.99 |
| X4 | ND | ND |
| X5 | −16.39 | 237.63 |
| X6 | ND | ND |
| X7 | ND | ND |
| X8 | ND | ND |
| X9 | ND | ND |
| X10 | 18.89 | 255.51 |
| X11 | 7.5 | 208.32 |

As can be seen in the table above, the precursors only start rapid thermal degradation around 200° C. or higher (T_{deg} onset). This indicates that it is safe to process the precursors up to this temperature as long as the residence time is limited, and an inert atmosphere is applied. Additionally, precursors with different glass transition temperatures are shown (T_{g}), again indicating the tunability of the precursor with regard to the temperature at which the shape-memory effect is triggered.

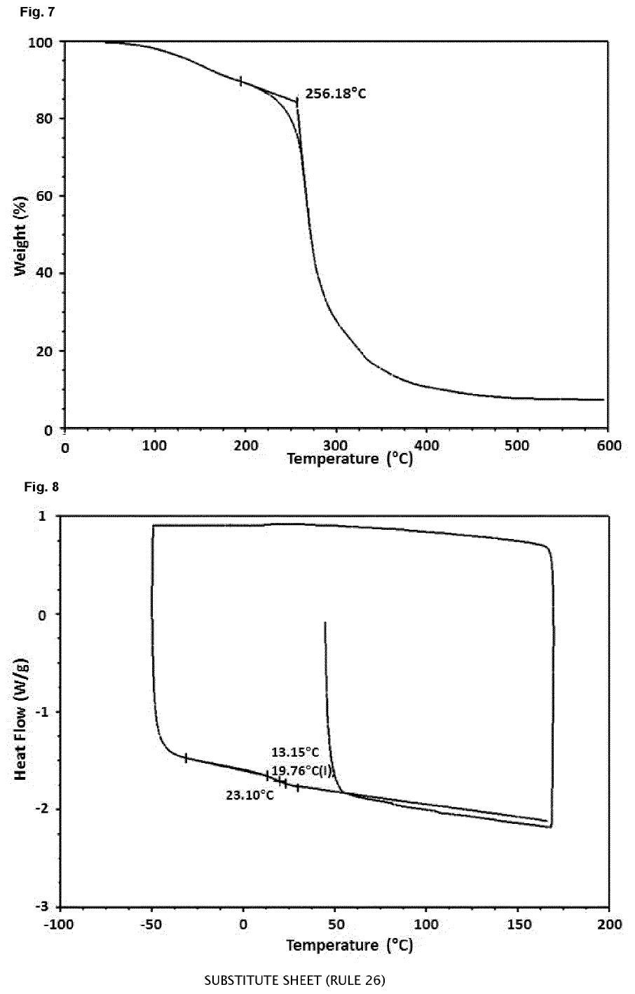

FIG. 7 shows a TGA thermogram of a precursor according to the present invention, the thermogram of precursors X10.

FIG. 8 shows a DSC thermogram, which is used for the determination of the glass transition temperature, of precursor X10. The absence of a crystallization peak indicates that the precursor is amorphous.

### REFERENCES

1. Li, Zhiquan & Torgersen, Jan & Ajami, A. & Muhleder, Severin & Qin, Xiao-Hua & Husinsky, Wolfgang & Holnthoner, Wolfgang & Ovsianikov, Aleksandr & Stampfl, Jurgen & Liska, Robert. (2013). Initiation efficiency and cytotoxicity of novel water-soluble two-photon photoinitiators for direct 3D microfabrication of hydrogels. RSC Advances. 10.1039/C3RA42918K.
2. Tromayer, Maximilian & Dobos, Agnes & Gruber, Peter & Ajami, A. & Deck, Roman & Ovsianikov, Aleksandr & Liska, Robert. (2018). A biocompatible diazosulfonate initiator for direct encapsulation of human stem cells: Via two-photon polymerization. Polymer Chemistry. 9. 10.1039/C8PY00278A.
3. A. Alba, O. T. du Boullay, B. Martin-Vaca, D. Bourissou, (2015). Direct ring-opening of lactide with amines: application to the organo-catalyzed preparation of amide end-capped PLA and to the removal of residual lactide from PLA samples. Polymer Chemistry. 10.1039/C4PY00973H.

1. A precursor of a shape-memory polymer, the precursor comprising a polymer backbone connected to cross-linkable end-capping urethane- and/or urea units, wherein the polymer backbone has an amorphous backbone having a crystallinity of about 0%, wherein about means+/−5% or less, as measured by any of the following techniques: differential scanning calorimetry (DSC), dynamic mechanical thermal analysis (DMTA), and/or Wide-angle X-ray scattering (WAXS).

2. The precursor according to claim 1, wherein the precursor is of formula (I):
(Xₘ—Yₘ—Zₘ)ₙ—backbone (I)
wherein:
Xₘ represents a moiety comprising one or more cross-linkable functionalities;
Yₘ is selected from the list comprising: a direct bond or a spacer;
Zₘ represents a urethane- and/or urea-containing moiety; and
wherein n is integer and defines the number of arm/branch cross-linkable end-capping urethane- and/or urea units connected to the backbone, wherein n≥2, and m is an enumerator for each arm/branch.

3. The precursor according to any one of claims 1 to 2, consisting of the polymer backbone connected to cross-linkable end-capping urethane- and/or urea units.

4. The precursor according to any one of the claims 1 to 3, wherein the polymer backbone comprises polylactic acid (PLA) or co-polymers thereof.

5. The precursor according to any one of claims 1 to 4, wherein the polymer backbone has a glass transition temperature T_{g}≥−20° C., measured by means of differential scanning calorimetry (DSC) and/or dynamic mechanical thermal analysis (DMTA).

6. The precursor according to any one of claims 2 to 5, wherein Yₘ is a spacer.

7. The precursor according to any one of claims 2 to 6, wherein the cross-linkable functionalities are selected from the list comprising: (meth)acrylate, thiols (for thiol-ene chemistry), norbornene (for thiol-ene chemistry), vinyl ethers, vinyl esters and combinations thereof.

8. The precursor according to any one of claims 1 to 6, wherein the precursor has an end-capping content from 0.2 to 300 mmol/g, preferably 0.3 to 250 mmol/g, more preferably 0.4 to 200 mmol/g.

9. The precursor according to any one of claims 1 to 8, wherein the amorphous backbone has a molar mass Mn from 500 to 100000 g/mol, preferably 1000 to 50000 g/mol, more preferably 1500 to 20000 g/mol, as determined by means of 1H-NMR spectroscopy through end-group determination.

10. The precursor according to any one of claims 1 to 9, having a polymer shape selected from: star-shape, linear, hyperbranched, brush, comb, dumbbell, dendritic, wherein said star-shape is: 3-armed, 4-armed, 6-armed, preferably 6-armed shape.

11. A precursor polymer solution comprising the precursor according to any one of claims 1 to 10, and a diluent, either solid or liquid, chemically inert to the precursor.

12. Use of a precursor as defined in anyone of claims 1 to 10, or the precursor polymer solution according to claim 11, in the medical and non-medical industry, or in a method selected from the list comprising: multiphoton lithography, stereolithography (SLA printing), Digital light projection (DLP), electro-spinning, film casting, porogen leaching, extrusion based 3D-printing, inkjet 3D-printing, spray drying, cryogenic treatment, coatings, cross-linkable micelles, spin-coating, electro-spraying, melt-electro writing, doctor blading.

13. A method for providing a shape-memory polymer, comprising the steps of:
(a) providing a precursor of a shape-memory polymer according to any one of claims 1 to 10, or a precursor polymer solution according to claim 11;
(b) cross-linking the precursor or the precursor polymer solution provided in step (a), thereby obtaining a cross-linked polymer having a first shape.

14. The method according to claim 13, wherein at step (b) the precursor or precursor polymer solution provided in step (a) is chemically cross-linked.

15. The method according to any one of claims 13 to 14, wherein at step (b) the precursor or precursor polymer solution is crosslinked in the absence of a reactive diluent.
